(19) United States
(12) Patent Application Publication
(10) Pub. No.: US 2021/0286747 A1
(43) Pub. Date: Sep. 16, 2021

(54) SYSTEMS AND METHODS FOR SUPPORTING INTER-CHASSIS MANAGEABILITY OF NVME OVER FABRICS BASED SYSTEMS

(71) Applicant: Samsung Electronics Co., Ltd., Suwon-si (KR)

(72) Inventors: Sompong Paul OLARIG, Pleasanton, CA (US); Son T. PHAM, San Ramon, CA (US); Ramdas KACHARE, Pleasanton, CA (US); Wentao WU, Milpitas, CA (US)

(21) Appl. No.: 17/336,877

(22) Filed: Jun. 2, 2021

Related U.S. Application Data
(63) Continuation of application No. 15/969,642, filed on May 2, 2018.
(60) Provisional application No. 62/595,036, filed on Dec. 5, 2017.
(60) Provisional application No. 62/633,964, filed on Feb. 22, 2018.

(51) Int. Cl. G06F 13/40; G06F 13/16; G06F 3/06

(52) U.S. Cl. CPC G06F 13/4022; H04L 61/2076; G06F 3/0688; G06F 13/1668

(57) ABSTRACT

A data storage system includes: a plurality of Ethernet solid-state drive (SSD) chassis including at least one switching Ethernet SSD chassis and one or more switchless Ethernet SSD chassis. The at least one switching Ethernet SSD chassis comprises an Ethernet switch, a first baseboard management controller (BMC), and a first management local area network (LAN) port. At least one of the one or more switchless Ethernet SSD chassis comprises an Ethernet repeater, a second BMC, and a second management LAN port. The first management LAN port of the at least one switching Ethernet SSD chassis and the second management LAN port are connected. The first BMC collects status of the at least one of the one or more switches Ethernet SSD chassis from the second BMC via a connection between the first management LAN port and the second management LAN port and provide device information of the at least one of the one or more switches Ethernet SSD chassis and the at least one switching Ethernet SSD chassis to a system administrator.

### CROSS-REFERENCE TO RELATED APPLICATION(S)

This application is a continuation application of U.S. patent application Ser. No. 15/969,642 filed May 2, 2018, which claims the benefits of and priority to U.S. Provisional Patent Application Ser. No. 62/595,036 filed Dec. 5, 2017 and 62/633,964 filed Feb. 22, 2018, the disclosures of which are incorporated herein by reference in their entirety.

### TECHNICAL FIELD

The present disclosure relates generally to a data storage system and management of the data storage system, more particularly, to a system and method for supporting inter-chassis manageability of a data storage system based on non-volatile memory express over fabrics (NVMe-oF).

### BACKGROUND

Data storage systems based on non-volatile memory express (NVMe) over fabrics (NVMe-oF) may have an Ethernet switch that connects to multiple NVMe-oF devices within an NVMe-oF chassis. The Ethernet switch included in the NVMe-oF chassis may have a sufficient number of Ethernet ports to support additional NVMe-oF chassis that are deficient of an Ethernet switch. Such an NVMe-oF chassis without an Ethernet switch is commonly referred to as just a bunch of flash (JBoF).

Each NVMe-oF chassis can have at least one motherboard, and each motherboard has a baseboard management controller (BMC). The BMC may be a low-power controller embedded in the motherboard of an NVMe-oF chassis. In addition to the BMC, the motherboard of the NVMe-oF chassis includes an Ethernet switch, a local central processing unit (CPU), a memory, and a peripheral component interconnect express (PCIe) switch. The BMC can read environmental and operating conditions of the corresponding NVMe-oF chassis using various sensors embedded in the chassis and Ethernet SSDs attached to the chassis and control the NVMe-oF chassis and the Ethernet SSDs based on commands from a system administrator or a condition of the sensors. The BMC may access and control various components of the NVMe-oF chassis through a local system bus such as a system management bus (SMBus) and a PCIe bus.

For a data storage system based on NVMe-oF, there is a need for connecting multiple NVMe-oF chassis with Ethernet switch or Ethernet switchless chassis together. The Ethernet switchless chassis maybe called as Just-a-Bunch-of Flash (JBoF) chassis. In some examples, JBoF chassis may have an Ethernet repeater or re-timer instead of an Ethernet switch to reduce the cost of a data storage system. Currently, no standard protocols are available enabling connection of multiple NVMe-oF chassis and facilitating configuration, control, and management using inter-chassis communication.

### SUMMARY

According to one embodiment, a data storage system includes: a plurality of Ethernet solid-state drive (SSD) chassis including at least one switching Ethernet SSD chassis and one or more switchless Ethernet SSD chassis. The at least one switching Ethernet SSD chassis comprises an Ethernet switch, a first baseboard management controller (BMC), and a first management local area network (LAN) port. At least one of the one or more switchless Ethernet SSD chassis comprises an Ethernet repeater, a second BMC, and a second management LAN port. The first management LAN port of the at least one switching Ethernet SSD chassis and the second management LAN port are connected. The first BMC collects status of the at least one of the one or more switches Ethernet SSD chassis from the second BMC via a connection between the first management LAN port and the second management LAN port and provide device information of the at least one of the one or more switches Ethernet SSD chassis and the at least one switching Ethernet SSD chassis to a system administrator.

According to another embodiment, a data storage system includes: a switching Ethernet SSD chassis comprising an Ethernet switch, a baseboard management controller (BMC), and a management LAN port; and a first switchless Ethernet SSD chassis and a second switchless Ethernet SSD chassis. Each of the first switchless Ethernet SSD chassis and the second switchless Ethernet SSD chassis comprises an Ethernet repeater, a BMC, and a management LAN port that is connected to each other and to the management LAN port of the switching Ethernet SSD. The BMC of the second switchless Ethernet SSD chassis provides device information of the second switchless Ethernet SSD chassis to the BMC of the first switchless Ethernet SSD chassis via the management LAN port. The BMC of the first switchless Ethernet SSD chassis provides device information of the first switchless Ethernet SSD chassis and the second switchless Ethernet SSD chassis to the BMC of the switching Ethernet SSD chassis via the management LAN port. The BMC of the switching Ethernet SSD chassis provides device information of the switching Ethernet SSD chassis, the first switchless Ethernet SSD chassis, and the second switchless Ethernet SSD chassis to a system administrator connected over a fabric network.

According to another embodiment, a method includes: selecting a candidate BMC among a plurality of BMCs in a domain, wherein the domain comprises a plurality of Ethernet solid-state drive (SSD) chassis including at least one switching Ethernet SSD chassis and one or more switchless Ethernet SSD chassis; broadcasting to the plurality of BMCs in the domain to claim presidency of the domain; checking qualification of the candidate BMC based on responses received from the plurality of BMCs; and electing the candidate BMC as a president BMC of the domain based on the qualification. The president BMC is included in a first switching Ethernet SSD chassis including a first Ethernet switch. The president BMC collects device information of the plurality of Ethernet SSD chassis in the domain to a system administrator over a fabric network.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles described herein.

FIG. 1 shows an example data structure of an IPMI message in an Ethernet frame;

FIG. 2A shows an architecture of an example NVMe-oF domain including multiple boards, according to one embodiment;

FIG. 2B shows an architecture of an example NVMe-oF domain including multiple boards, according to another embodiment;

FIG. 3 is an example flowchart for electing a president BMC in a domain, according to one embodiment;

FIG. 4 is an example flowchart of replacing a president BMC in a domain, according to one embodiment;

FIG. 5 shows a domain of an example NVMe-oF domain without a domain Ethernet switch, according to one embodiment;

FIG. 6 shows an example data flow in a domain of an example NVMe-oF domain, according to one embodiment; and

FIG. 7 shows a flowchart for processing a device information request, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

Each of the features and teachings disclosed herein can be utilized separately or in conjunction with other features and teachings to provide a system and method for supporting inter-chassis manageability of an NVMe-oF-based data storage system. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are used by those skilled in the data processing arts to effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of an original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

The present disclosure a system and method for supporting inter-chassis manageability of an NVMe-oF-based system. The NVMe-oF protocol provides a transport-mapping mechanism for exchanging commands and responses between a host computer and a target storage device over a fabric network such as Ethernet, Fibre Channel, and InfiniBand using a message-based model. The present system allows a system administrator to manage a group of or a domain of BMCs without directly managing BMCs of each individual NVMe-oF domain. In each group/domain, one of the BMCs in the group/domain is designated to function as a “president” of the group/domain. The president may provide discovery information of other BMCs within the group/domain. The president may also manage the status of all BMCs in the group/domain and report to the system administrator. The system administrator may contact the president to get status of all member BMCs and use the president BMC as a proxy to perform certain actions to a specific member BMC or all member BMCs of the group/domain.

To achieve the manageability of a domain/group, the present system requires connectivity topology to connect multiple BMCs. According to one embodiment, the present system and method provides an external management switch that provides the connectivity among BMCs within a group/domain. Each NVMe-oF chassis' management LAN port may be connected to the management switch (e.g., 1 Gb switch). In some embodiments, some of the NVMe-oF chassis' management LAN ports may be connected in a daisy chain.

According to one embodiment, the present system and method provides inter-BMC communication protocols. For example, new IPMI commands can be added to extend the standard IPMI-over-LAN protocol to facilitate the inter-chassis manageability. The extended IPMI protocol on top of UDP/IP can provide features such as domain communication, discovery, etc. that the standard IPMI-over-LAN protocol is not suitable for. In additional to the existing system information, the present system and method can support exchange of new system information, including, but not limited to, configuration of the Ethernet SSD boards in the domain, network configuration of the switching boards in the domain, assign static IPs to the Ethernet SSDs (eSSDs) attached to boards, and restarting a dynamic host configuration protocol (DHCP) client to get IP addresses for the eSSDs.

The first BMC to come up can be selected as a domain president, or a particular BMC within the domain/group can be designated as the president. In some embodiments, the system administrator maintains a list and a rank of BMCs that can be elected as the president. In some embodiment, the election of the president can be done through arbitration. When the president BMC is out of service, the next president may be selected from the remaining active member BMCs.

In general, the BMC of an NVMe-oF chassis may be connected to an administrator over a management local area network (LAN). The system administrator can monitor multiple NVMe-oF chassis directly over the management LAN via the intelligent platform management interface (IPMI) protocol. The IPMI protocol allows communication between the system administrator and the BMC over the management LAN using IPMI messages. An IPMI message is encapsulated in a remote management control protocol (RMCP/RMCP+) packet as defined by the Distributed Management Task Force (DMTF).

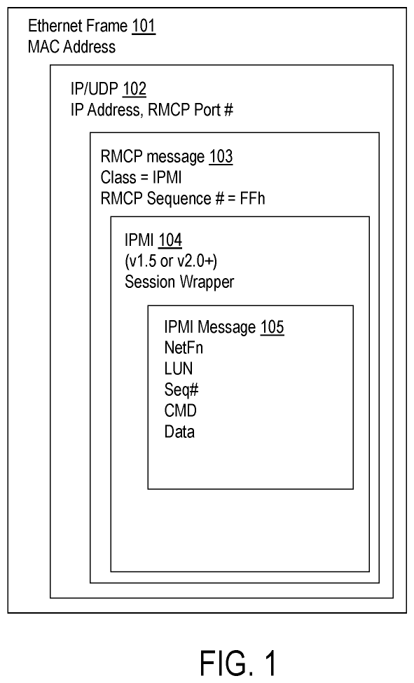

FIG. 1 shows an example data structure of an IPMI message in an Ethernet frame. An IPMI message 105 includes a network function (NetFn), a logical unit number (LUN), a sequence number (Seq#), a command (CMD), and data. The IPMI message 105 is wrapped in an Ethernet frame 101. The Ethernet framing 101 includes a MAC address and wraps an IP/UDP packet 102. The IP/UDP packet 102 includes an IP address and an RMCP port number and wraps an RMCP message 103. The RMCP message 103 includes a class of the message (e.g., IPMI) and an RMCP sequence number and wraps an IPMI packet 104. The IPMI packet 104 includes a session wrapper and includes the IPMI message 105.

According to one embodiment, the present system and method enable inter-chassis communication among different NVMe-oF chassis to minimize a system cost. To achieve the cost saving, one NVMe-oF chassis in a domain/group may include an Ethernet switch while other chassis do not. In such case, the chassis lacking an Ethernet switch would include a switchless board that is otherwise similar to the chassis including an Ethernet switch board except they do not include a costly Ethernet switch. The following description is based on an Ethernet connection among the multiple BMCs. However, it is understood that the present system and method may use other types of network-based connection and protocols. The present system and method may require no additional cable(s) other than a network cable for the implementation of the inter-chassis communication.

According to one embodiment, the present disclosure provides inter-chassis communication among multiple BMCs through an external Ethernet switch and provides a cost-effective manageability of a multi-chassis NVMe-oF domain. The inter-chassis communication may be implemented using standard interfaces with extended IPMI protocol.

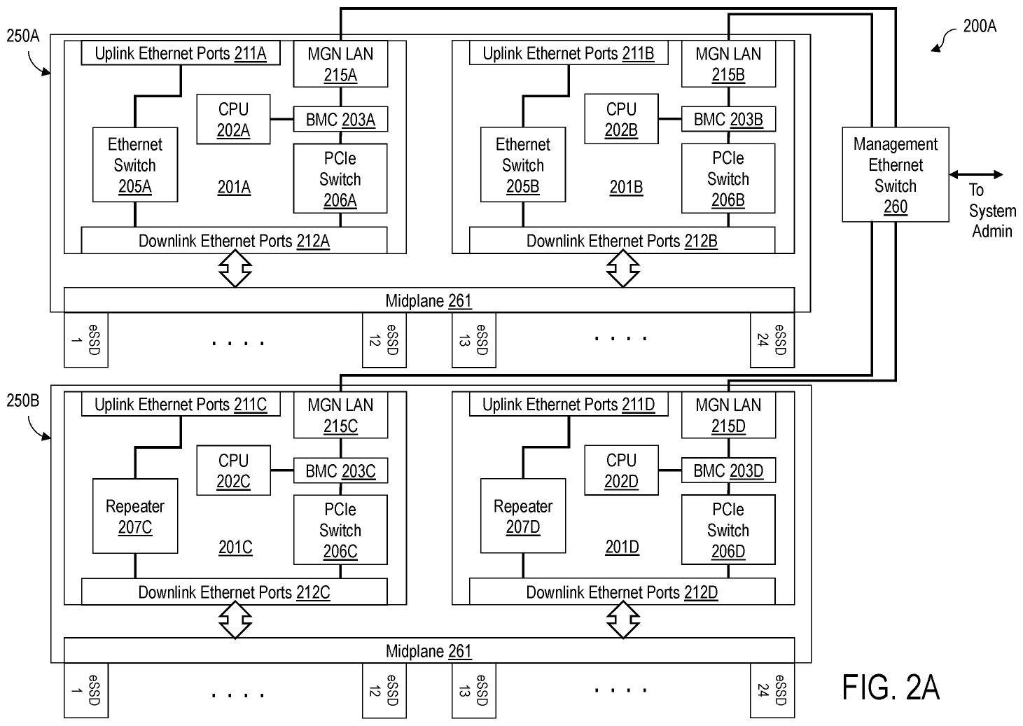

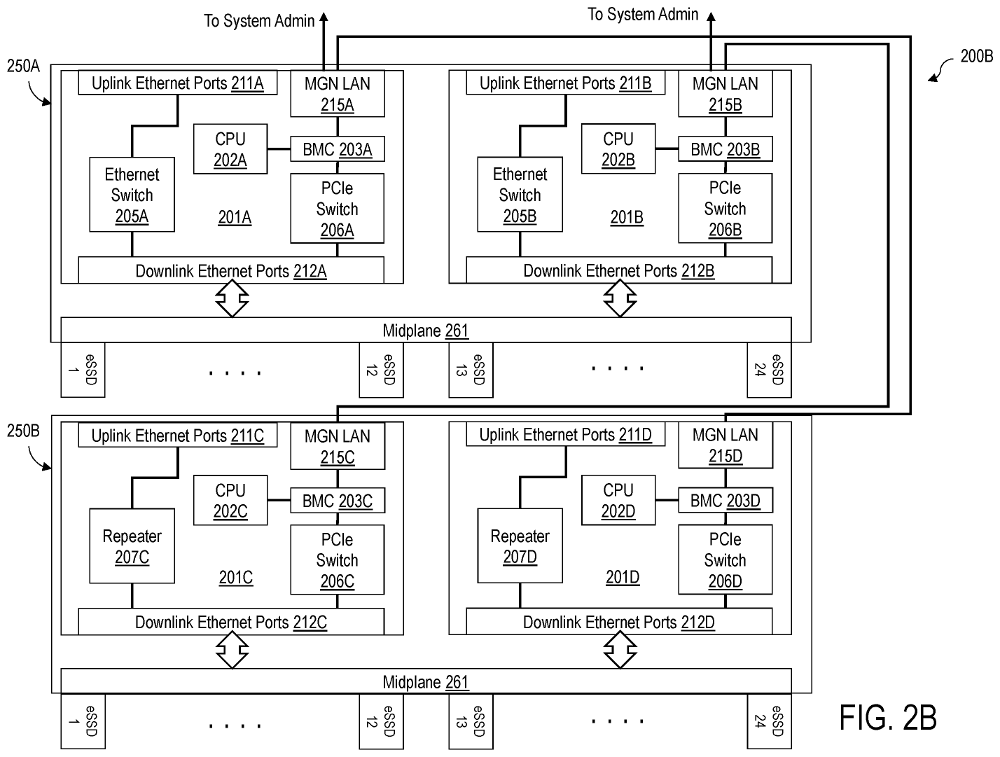

FIG. 2A shows an architecture of an example NVMe-oF domain including multiple boards, according to one embodiment. The NVMe-oF domain 200A includes two NVMe-oF chassis 250A and 250B, and each of the NVMe-oF chassis includes two NVMe-oF boards 201 of the same kinds, i.e., either Ethernet switching boards or switchless boards. In the present example, the first NVMe-oF chassis 250A includes two switching boards 201A and 201B, and the second NVMe-oF chassis 250B includes two switchless boards 201C and 201D. The NVMe-oF domain 200A may herein also referred to as an NVMe-oF cluster or an eSSD cluster. In some embodiment, the NVMe-oF chassis including one or more Ethernet switching boards may be referred to as an Ethernet switching chassis or an Ethernet switching SSD chassis.

Both of the switching boards 201A and 201B include an Ethernet switch 205 while the switchless boards 201C and 201D include a repeater 207 (or a re-timer) instead of an Ethernet switch 205. It is noted that the NVMe-oF domain 200A is configured with two switching boards and two switchless boards as an example, and it is understood that the NVMe-oF domain 200A can have different configuration including a more or less number and different types of boards in a plurality of NVMe-oF chassis without deviating from the scope of the present disclosure.

Each of the NVMe-oF board 201 can include other components and modules, for example, a local CPU 202, a BMC 203, a PCIe switch 206, uplink Ethernet ports 211, downlink Ethernet ports 212, and a management LAN port 215. Several Ethernet solid-stated drives (eSSDs) can be plugged into device ports of the NVMe-oF board 201 via a midplane 261. For example, each of the eSSDs is connected to a U.2 connector (not shown) on the midplane 261. An eSSD plugged into the drive bay and mated with the midplane 261 is herein also referred to as an NVMe-oF device or an Ethernet SSD (eSSD). The NVMe-oF chassis boards 201C and 201D that are deficient of its own internal Ethernet switch are herein also referred to as NVMe-oF just a bunch of flash (JBOF).

A management LAN (not shown) includes a management Ethernet switch 260 that connects to the management LAN ports 215 of all NVMe-oF boards 201 in the NVMe-oF domain 200A. The management LAN port 215 may be an Ethernet port. The BMCs 203 of the switching or switchless boards 201 are connected to the management Ethernet switch 260 via the management LAN port 215. The management Ethernet switch 260 provides connectivity between multiple NVMe-oF chassis 250 and a system administrator to allow the system administrator to monitor the NVMe-oF chassis over the management LAN ports 215 using the intelligent platform management interface (IPMI) protocol. In addition, the BMC 203 can report errors of the NVMe-oF chassis 250 to the system administrator via the IPMI protocol. In one embodiment, the management Ethernet switch 260 may be included in a separate chassis from the NVMe-oF chassis 250A or 250B but within the same rack. The uplink Ethernet ports 211 of the switchless board 201C or 201D may be connected to the internal Ethernet switch 205 of the coupled switching board 201A or 201B to route Ethernet traffic between a host computer (or an initiator) and the target eSSDs attached to the switchless board 201C and 201D.

The NVMe-oF domain 200A may have at least one president BMC 203. The president BMC of the NVMe-oF domain 200A can be elected in several ways. In a domain that has only one switching board including an Ethernet switch, the BMC of the switching NVMe-oF board is elected as the president BMC by default. The rest of the switchless boards are JBOF without an embedded Ethernet switch. In this case, the JBOFs of the switchless boards are connected to the Ethernet switch 205 of the switching board, and they are functional through the switching board with the Ethernet switch 205.

In a group/domain with multiple switching boards including multiple BMCs, an uptime of the BMCs (i.e., the continuous running time period of the BMCs without being power down or failure) may be used to determine the president BMC by comparing the uptime of all qualified candidate BMCs in the domain. It is possible that some BMCs in the group/domain may or may not be qualified as a president BMC. For example, the BMC that has the longest uptime is elected as the president BMC. In another example, the BMC that has the lowest or highest IP address among the candidate BMCs may be elected as the president BMC.

FIG. 2B shows an architecture of an example NVMe-oF domain including multiple boards, according to another embodiment. The NVMe-oF domain 200B is substantially similar to the NVMe-oF domain 200A of FIG. 1A except that there is no management Ethernet switch. In this case, the BMCs 203C and 203D report to the president BMC, for example, the BMC 203A of the switching board 201A via the respective management LAN ports 215. When there are two switching boards present in an NVMe-oF chassis (e.g., NVMe-oF chassis 250A) to support a high availability (HA) mode, one of the BMCs (e.g., BMC 203A) is active while the other BMC (e.g., BMC 203B) may be inactive. Any of the non-president BMC (e.g., BMCs 203C, and 203D) may collect information of other BMCs within the domain and report the collective information to the president BMC 203A in a daisy chain. For example, the BMC 203C may report the status of one or more other NVMe-oF chassis (not shown) through the communication among the BMCs. In a case the president BMC 203A fails or powered down, the BMC 203B of the switching board 201B may be elected as the president BMC, and report the status of the NVMe-oF chassis within the domain to the system administrator.

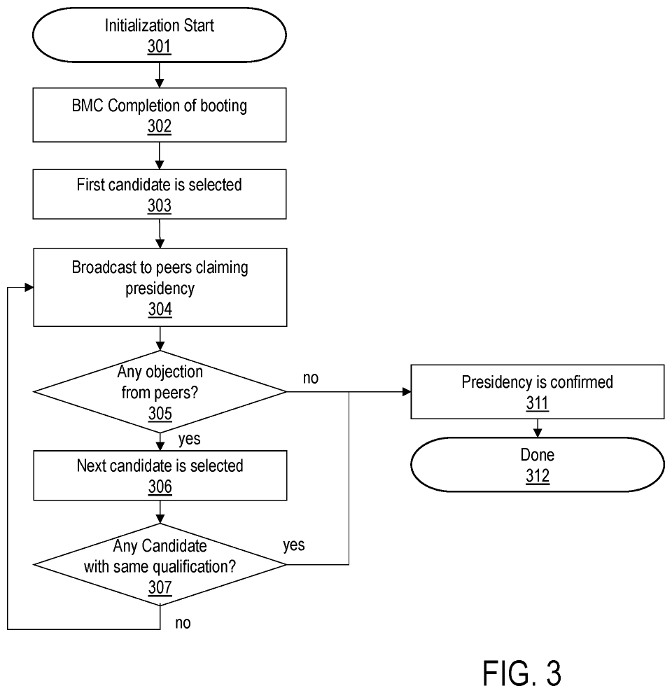

FIG. 3 is an example flowchart for electing a president BMC in a domain, according to one embodiment. After an initialization process starts (301), the BMCs within a domain complete booting successfully and are ready (302). For example, the domain can contain one or more chassis including switching or switchless Ethernet SSD chassis as shown in FIG. 2. In another example, the domain may encompass more than one NVMe-oF chassis in the same rack or over multiple racks within a datacenter. A candidate BMC is selected based on a default selection criterion (303) and broadcasts to other peer BMCs to claim the presidency (304). For example, the candidate BMC may be the BMC of a switching board with the longest uptime. In a domain that has only one candidate BMC, the only candidate BMC may claim its presidency without broadcasting to other peer BMCs. In another example, the candidate BMC may be selected based on different selection criteria other than the uptime, for example, an IP address, a service set identifier (SSID), a MAC address, or other unique identifiers. If no objection is raised by the peer BMCs (305), the candidate BMC is confirmed to be elected as the president BMC (311), and the election process is completed (312). If any objection is raised by the peer BMCs (305), the next candidate BMC of a switching board is selected (306). For example, the BMC of a switching board having the second longest uptime is selected. If the selected candidate BMC has the same qualification as the previous candidate BMC that has been objected (307), the candidate BMC can be elected as the president BMC (311). If the qualification of the candidate BMC is different from the previously objected candidate BMC, the candidate BMC broadcasts to other peer BMCs to claim the presidency (304). The process repeats until the president BMC is elected. If no president BMC is elected, an error is reported to the system administrator.

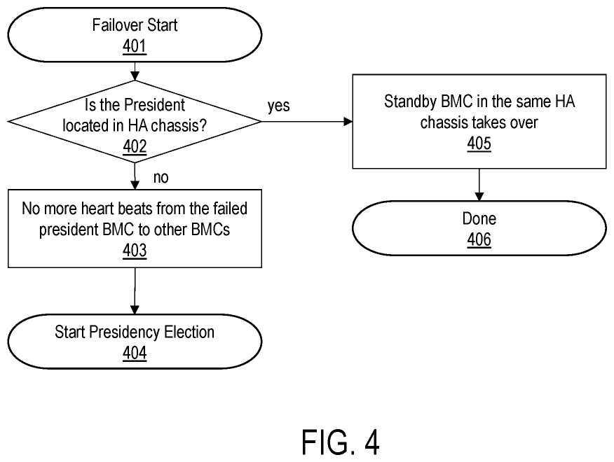

FIG. 4 is an example flowchart of replacing a president BMC in a domain, according to one embodiment. A failover process starts when the current president BMC fails the system administrator receives a report of a problem regarding the president BMC (401). First, it is checked if the failed president BMC is located in a HA chassis including two or more switching boards (402). If so, a standby BMC in the same HA chassis takes over the presidency (405), and the process completes (405). If it is confirmed that no more heart beats are sent from the failed president BMC to other peer BMCs (403), and the president election process as shown in FIG. 3 is restarted (404).

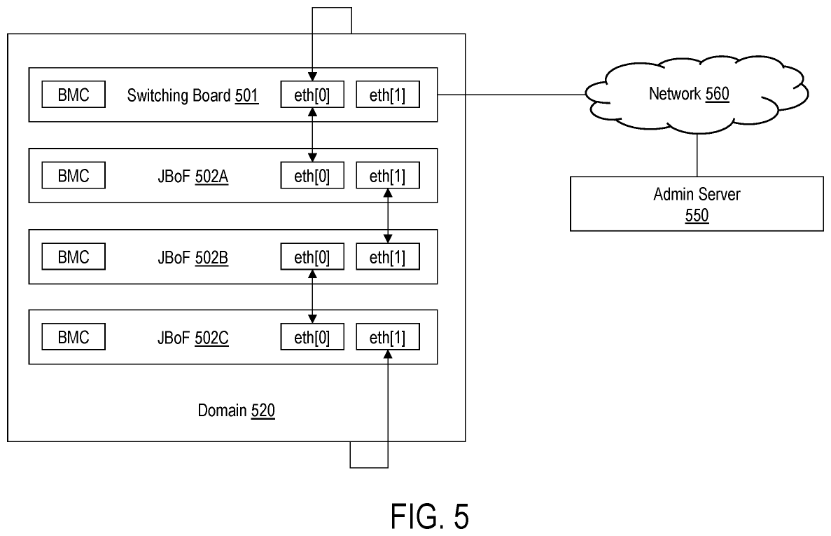

FIG. 5 shows a domain of an example NVMe-oF domain without a domain Ethernet switch, according to one embodiment. A domain 520 includes a switching board 501 and a plurality of switchless boards (JBoFs). Each of the switching board 501 and the switchless boards 502 has two Ethernet ports eth[0] and eth[1] that are daisy chained to connect to each other. The Ethernet ports eth[0] and eth[1] represents the management LAN ports 215 of FIGS. 2A and 2B. For example, the first Ethernet port eth[0] of the JBoF 502A is connected to the first Ethernet port eth[0] of the switching board 501, and the second Ethernet port eth[1] of the JBoF 502A is connected to the second Ethernet port eth[1] of the next JBoF 502B. The daisy chain connection of the Ethernet ports allows that the president BMC of the switching board 501 to communicate the peer BMCs of the JBoFs 502. The president BMC can manage and report the device information of the JBoFs 502 in the domain 520 to an admin server 550 over a network 560 (e.g., Ethernet). Although the present example shows one switching board and three switchless boards in the domain 520, it is understood that at least one switching board and any number of switchless boards may be included in the domain 520 without deviating from the scope of the present disclosure.

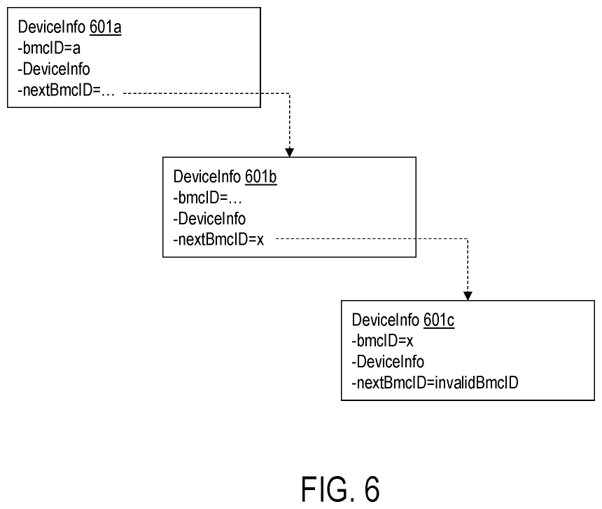

FIG. 6 shows an example data flow in a domain of an example NVMe-oF domain, according to one embodiment. A device information 601a of a switching board or a switchless board includes a BMC ID, device-specific information, and a next BMC ID. The next BMC ID points to another device information 601b, and so on. The president BMC can collect and aggregate the device information of the Ethernet SSD boards within the domain and report to the system administrator. The president BMC can also receive commands from the system administrator to act on (e.g., changing configuration or parameters) a specific board through a peer-to-peer communication between the BMCs within the domain.

Referring to FIG. 5, the present NVMe-oF domain may not include a domain Ethernet switch to reduce the cost and simplify configuration of the system. The present NVMe-oF domain provides peer-to-peer communication and management. Once the president BMC is elected, the president BMC can send a request, and the request may be passed down to a target BMC via a direct connection or a daisy chain connection through one or more intermediate boards. The president BMC can collect and aggregate device information from each BMC in the domain and report to the system administrator via the network.

According to one embodiment, the present system and method provides a recursive request process mechanism to collect all BMC device information in the same domain. Each BMC has its own BMC ID and two management LAN ports including an upstream port and a downstream port. Each of the upstream port and the downstream port may have a unique IP address and a MAC address. Each BMC is responsible for managing its own device information. The BMC may be further responsible for discovering a downstream BMC ID and passing the device information from the downstream BMC received via the downstream port to the upstream BMC via the upstream port. The president BMC may not have an upstream port to report. Instead, the president BMC may trigger BMC discovery to the peer BMCs, process device information from the peer BMCs to identify addition of a newly added BMC or removal of an existing BMC in the domain, and perform necessary management tasks. An end BMC at the end of the daisy chain may not have a downstream BMC. In this case, the end BMC reports its device information to the upstream BMC when the upstream BMC queries.

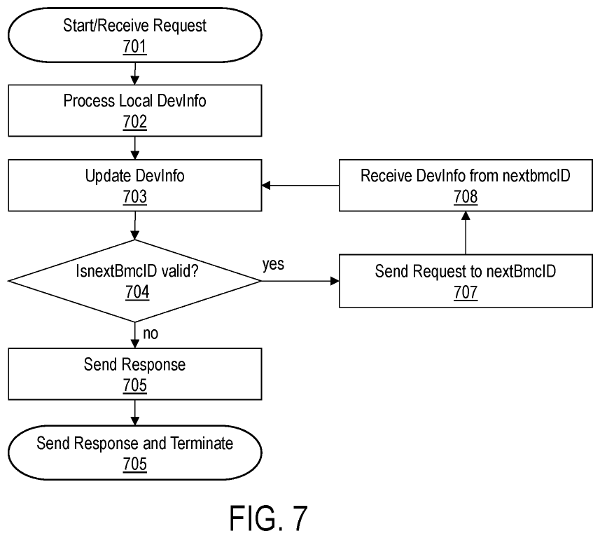

FIG. 7 shows a flowchart for processing a device information request, according to one embodiment. A BMC in a domain starts/receives a request from an upstream BMC or a president BMC in the domain (701). In response to the request, the BMC processes its local device information (702) and update the device information for reporting to the requesting BMC (703). If the next BMC ID valid (704), in other words, if the BMC has a downstream BMC in a daisy chain, the BMC sends a request to the next BMC to send its device information (707), receives the requested device information from the next BMC (708), and updates the device information appending the device information from the downstream BMC (703). If there is no valid next BMC, the BMC sends the collected device information to the requesting BMC (705) and terminates the process (706).

According to one embodiment, a data storage system includes: a plurality of Ethernet solid-state drive (SSD) chassis including at least one switching Ethernet SSD chassis and one or more switchless Ethernet SSD chassis. The at least one switching Ethernet SSD chassis comprises an Ethernet switch, a first baseboard management controller (BMC), and a first management local area network (LAN) port. At least one of the one or more switchless Ethernet SSD chassis comprises an Ethernet repeater, a second BMC, and a second management LAN port. The first management LAN port of the at least one switching Ethernet SSD chassis and the second management LAN port are connected. The first BMC collects status of the at least one of the one or more switches Ethernet SSD chassis from the second BMC via a connection between the first management LAN port and the second management LAN port and provide device information of the at least one of the one or more switches Ethernet SSD chassis and the at least one switching Ethernet SSD chassis to a system administrator.

The data storage system may further include a management Ethernet switch. The first BMC may connect to the management Ethernet switch via the first management LAN port, and the second BMC may connect to the management Ethernet switch via the second management LAN port. The first BMC may provide the device information of the at least one of the one or more switches Ethernet SSD chassis and the at least one switching Ethernet SSD chassis to the system administrator via the management Ethernet switch.

The at least one switching Ethernet SSD chassis may support transportation of messages between a host computer and the data storage system over a fabric network.

The system administrator may send a request or a command to one of the first BMC and the second BMC in the data storage system using an intelligent platform management interface (IPMI) message.

The request or the command may support discovery of a newly added Ethernet SSD in a domain and restarting and configuration of one or more Ethernet SSDs attached to one of the plurality of Ethernet SSD chassis using static IPs or via a dynamic host configuration protocol (DHCP).

At least one of the one or more switchless Ethernet SSD chassis may further include the Ethernet SSDs (eSSDs).

According to another embodiment, a data storage system includes: a switching Ethernet SSD chassis comprising an Ethernet switch, a baseboard management controller (BMC), and a management LAN port; and a first switchless Ethernet SSD chassis and a second switchless Ethernet SSD chassis. Each of the first switchless Ethernet SSD chassis and the second switchless Ethernet SSD chassis comprises an Ethernet repeater, a BMC, and a management LAN port that is connected to each other and to the management LAN port of the switching Ethernet SSD. The BMC of the second switchless Ethernet SSD chassis provides device information of the second switchless Ethernet SSD chassis to the BMC of the first switchless Ethernet SSD chassis via the management LAN port. The BMC of the first switchless Ethernet SSD chassis provides device information of the first switchless Ethernet SSD chassis and the second switchless Ethernet SSD chassis to the BMC of the switching Ethernet SSD chassis via the management LAN port. The BMC of the switching Ethernet SSD chassis provides device information of the switching Ethernet SSD chassis, the first switchless Ethernet SSD chassis, and the second switchless Ethernet SSD chassis to a system administrator connected over a fabric network.

The fabric network may be one of Ethernet, Fibre Channel, and InfiniBand.

The switching Ethernet SSD chassis may support transportation of messages between a host computer and the data storage system over the fabric network.

The system administrator may send a request or a command to the BMC of the switching Ethernet SSD chassis using an intelligent platform management interface (IPMI) message.

The request or the command may support discovery of a newly added Ethernet SSD in a domain and restarting and configuration of one or more Ethernet SSDs attached to one of the plurality of Ethernet SSD chassis using static IPs or via a dynamic host configuration protocol (DHCP).

The first and second switchless Ethernet SSD chassis may further include the one or more Ethernet SSDs (eSSDs).

According to another embodiment, a method includes: selecting a candidate BMC among a plurality of BMCs in a domain, wherein the domain comprises a plurality of Ethernet solid-state drive (SSD) chassis including at least one switching Ethernet SSD chassis and one or more switchless Ethernet SSD chassis; broadcasting to the plurality of BMCs in the domain to claim presidency of the domain; checking qualification of the candidate BMC based on responses received from the plurality of BMCs; and electing the candidate BMC as a president BMC of the domain based on the qualification. The president BMC is included in a first switching Ethernet SSD chassis including a first Ethernet switch. The president BMC collects device information of the plurality of Ethernet SSD chassis in the domain to a system administrator over a fabric network.

The device information of the plurality of Ethernet SSD chassis may be collected by peer-to-peer communication among the plurality of BMCs in the domain via a daisy chain.

The one or more switchless Ethernet SSD chassis may include a first switchless Ethernet SSD chassis and a second switchless Ethernet SSD chassis. The second switchless Ethernet SSD chassis may have a management LAN port connected to a management LAN port of the first switchless Ethernet SSD chassis, and a BMC of the second switchless Ethernet SSD chassis may send device information of the second switchless Ethernet SSD chassis to a BMC of the first switchless Ethernet SSD chassis.

The BMC of the first switchless Ethernet SSD chassis may send device information of the first switchless Ethernet SSD chassis and the second switchless Ethernet SSD chassis to the president BMC.

The first and second switchless Ethernet SSD chassis may further include one or more Ethernet solid-state drives (eSSDs).

The first Ethernet switch may have a highest uptime in the domain.

The method may further include: determining that the president BMC is down or out of service; selecting a second candidate BMC among the plurality of BMCs in the domain, wherein the second candidate BMC is included in a second switching Ethernet SSD chassis having a second Ethernet switch; and electing a new president BMC.

The second Ethernet switch may have a second longest uptime in the domain.

The above example embodiments have been described hereinabove to illustrate various embodiments of implementing a system and method for supporting inter-chassis manageability of an NVMe-oF-based data storage system. Various modifications and departures from the disclosed example embodiments will occur to those having ordinary skill in the art. The subject matter that is intended to be within the scope of the invention is set forth in the following claims.

What is claimed is:

1. A data storage system comprising:
a first Ethernet solid-state drive (SSD) chassis comprising a first Ethernet switch, a first baseboard management controller (BMC), and a first management port; and
a second Ethernet SSD chassis comprising an Ethernet repeater, a second BMC, and a second management port,
wherein the first BMC collects a status of the second Ethernet SSD chassis from the second BMC via a daisy chain connection that connects the first management port of the first Ethernet SSD chassis and the second management port of the second Ethernet SSD chassis and provides device information of the second Ethernet SSD chassis to a system administrator, and
wherein the daisy chain connection is reconfigured based on a status change of the first BMC of the first Ethernet SSD chassis.

2. The data storage system of claim 1, wherein the status change of the first BMC of the first Ethernet SSD chassis is detected by a failover process determining that the first BMC is down or out of service.

3. The data storage system of claim 1, further comprising a third Ethernet SSD chassis comprising a second Ethernet switch, a third BMC, and a third management port,
wherein the daisy chain connection connects the first management port of the first Ethernet SSD chassis, the second management port, and the third management port, and
wherein the first BMC collects a status of the third Ethernet SSD chassis from the second BMC via the daisy chain connection and provides device information of the third Ethernet SSD chassis to the system administrator.

4. The data storage system of claim 3, wherein the first management port of the first Ethernet SSD chassis is disconnected in the daisy chain connection based on the status change of the first BMC of the first Ethernet SSD chassis, and
wherein the third BMC collects the status of the second Ethernet SSD chassis from the second BMC via the daisy chain connection and provides the device information of the second Ethernet SSD chassis to the system administrator.

5. The data storage system of claim 1, wherein the data storage system further comprises a management Ethernet switch,
wherein the first BMC connects to the management Ethernet switch via the first management LAN port, and the second BMC connects to the management Ethernet switch via the second management LAN port, and wherein the first BMC provides the device information of the second Ethernet SSD chassis to the system administrator via the management Ethernet switch.

6. The data storage system of claim 1, wherein the first Ethernet SSD chassis supports transportation of messages between a host computer and the data storage system over a fabric network.

7. The data storage system of claim 6, wherein the fabric network is one of Ethernet, Fibre Channel, and InfiniBand.

8. The data storage system of claim 6, wherein the system administrator sends a request or a command to one of the first BMC and the second BMC in the data storage system using an intelligent platform management interface (IPMI) message.

9. The data storage system of claim 8, wherein the request or the command supports discovery of a newly added Ethernet SSD in a domain and restarting and configuration of one or more Ethernet SSDs attached to one of a plurality of Ethernet SSD chassis using static internet protocols (IPs) or via a dynamic host configuration protocol (DHCP).

10. The data storage system of claim 1, wherein each of the first Ethernet SSD chassis and the second Ethernet SSD chassis further comprises an Ethernet SSD (eSSD).

11. A method comprising:
establishing a daisy chain connection that connects a plurality of Ethernet solid-state drive (SSD) chassis in a domain including a first Ethernet SSD chassis and a second Ethernet SSD chassis;
selecting a first BMC of the first Ethernet SSD chassis as a candidate BMC among a plurality of BMCs of the plurality of Ethernet SSD chassis in the domain;
broadcasting to the plurality of BMCs in the domain to claim presidency of the domain;
checking qualification of the first BMC based on responses received from the plurality of BMCs; and
electing the first BMC as a president BMC of the domain based on the qualification,
wherein the first BMC is included in the first Ethernet SSD chassis that includes a first Ethernet switch,
wherein the first BMC collects device information of the plurality of Ethernet SSD chassis in the domain to a system administrator over a fabric network, and
wherein the daisy chain connection is reconfigurable based on a status change of the president BMC.

12. The method of claim 11, further comprising collecting the device information of the plurality of Ethernet SSD chassis by peer-to-peer communication among the plurality of BMCs in the domain via the daisy chain connection.

13. The method of claim 11, wherein the first Ethernet switch has a highest uptime in the domain.

14. The method of claim 11, further comprising:
determining that the president BMC is down or out of service;
selecting a second BMC of a third Ethernet SSD chassis among the plurality of BMCs in the domain, wherein the third Ethernet SSD chassis includes a second Ethernet switch; and
electing the second candidate BMC as the president BMC.

15. The method of claim 14, wherein the second Ethernet switch has a second longest uptime in the domain.

16. The method of claim 14, further comprising:
disconnecting the first Ethernet SSD chassis in the daisy chain connection based on the status change of the first BMC of the first Ethernet SSD chassis;
collecting, using the second BMC, a status of the second Ethernet SSD chassis from the second BMC via the daisy chain connection; and
providing, using the second BMC, the device information of the second Ethernet SSD chassis to the system administrator.

17. The method of claim 11, wherein the first Ethernet SSD chassis supports transportation of messages between a host computer and the plurality of Ethernet SSDs in the domain over a fabric network.

18. The method of claim 17, wherein the fabric network is one of Ethernet, Fibre Channel, and InfiniBand.

19. The method of claim 11, wherein the system administrator sends a request or a command to the first BMC in the domain using an intelligent platform management interface (IPMI) message.

20. The method of claim 19, wherein the request or the command supports discovery of a newly added Ethernet SSD in the domain and restarting and configuration of one or more Ethernet SSDs attached to one of the plurality of Ethernet SSD chassis using static internet protocols (IPs) or via a dynamic host configuration protocol (DHCP).
